(19) United States
(12) Patent Application Publication
(10) Pub. No.: US 2022/0167088 A1
(43) Pub. Date: May 26, 2022

(54) Conductive plane damper

(71) Applicant: Dayun Zhu, Changde,Hunan (CN)

(72) Inventor: Dayun Zhu, Changde,Hunan (CN)

(21) Appl. No.: 17/425,952

(22) PCT Filed: Dec. 31, 2019
(86) PCT No.: PCT/CN2019/130728

§ 371 Date: Jul. 27, 2021

(30) Foreign Application Priority Data
Jan. 28, 2019 (CN) 201920148671.0

(51) Int. Cl. H04R 7/10; H04R 7/20

(52) U.S. Cl. CPC H04R 7/10; H04R 2400/11; H04R 7/20

(57) ABSTRACT

The invention discloses a conductive plane damper, which includes an outer circle, an inner circle and several connecting parts; several the connecting parts are evenly distributed between the outer circle and the inner circle, connecting the outer circle and the inner circle; the conductive plane damper are provided with at least two pairs of voice coil welding points and wire welding points; the voice coil welding points are arranged on the inner circle, the wire welding points are arranged on the outer circle. The speaker with the conductive plane damper avoids the usage of the lead wire and the speaker losing sound because of breaking of the lead wire, thereby greatly reducing the thickness of the conductive plane damper and increasing the quality of the speakers.

### FIELD OF THE INVENTION

The present invention relates to speaker technical field, more particularly, to a kind of conductive plane damper.

### BACKGROUND OF THE INVENTION

Loudspeaker generally includes a magnet, a U-yoke, a cone, a voice coil, a film and a damper etc. The damper, also named positioning bracket, is generally used for mounting the position of the voice coil so that the horn can ensure the vertical movement between the voice coil and the cone when shaking. In the prior art, the wire is often sewn directly on the damper. When the horn sounds out, the wire and the damper resonate so as to beat up and down, forming a rope skipping phenomenon, affecting the vibration of the damper, resulting in sound distortion, affecting the sound effect of the speaker. However, the existing damper can not adjust the the amplitude of the beating, and needs to be improved.

Therefor, Chinese Patent CN201820724500.3 discloses a perforated wire damper, which includes a body. The body consists of multiple peaks and multiple valleys, the inner walls of the valleys are fixed to supporting boxes. Both sides of each of the supporting boxes are fixedly connected with an universal bearings respectively. The inner ring of the universal bearings is connected with a wire in a sliding mode. Two of the supporting boxes are connected with by the wire and located in the top of the peak so as to form a U-shaped arc. The wire are located in the supporting boxes and fixedly connected with a limiting plate. In the present invention, with the supporting boxes, it is beneficial for that the vibration effect of the damper is more delicate, the effect of the speaker and the horn are enhanced, with the limiting plate, it is beneficial for preventing the movement of the wire inside the supporting boxes so as to change the size of the U-shaped arc, so that the vibration of the peak is affected and reduced the sound effect; with the first spring and the second spring, it is beneficial for that the feeding bar is forced and buffered so as to effectively prevent the damage of the wire so as to affect the sound effect generated by the damper.

Although the Chinese patent CN201820724500.3 addresses the sound distortion of the damper caused by cables, the supporting boxes, the universal bearings and the limiting plate increase the thickness of the damper, which also make the speaker more weight and occupy large space, and the cable is easy to break, and the structure is very complex.

Chinese patent CN201721193063.9 discloses a conductive plate damper, which includes a layer, the bottom surface of the layer is linked with a first insulating layer, the top surface the layer is linked with a second insulating layer by glue, the first insulating layer is linked with a mental layer by glue; the first insulating layer, the mental layer, the glue and the second insulating layer have the same plane structure, which includes an outer circle, an inner circle and a connecting part. The periphery of the inner circle is provided with the outer circle. The inner circle and the outer circle are connected by the connecting part. The connecting part is six S-shaped structure, the conductive plate damper also includes a first welding section and a second welding section except the inner circle, the outer circle and the connecting part. The first welding section and the second welding section are located in an elongated portion located at upper and lower ends of the outer circle. The first welding section is linked with the second welding section by the two S-shaped structures at the upper and lower ends, the second welding section is located with the other end of the two S-shaped structures at the upper and lower ends.

Chinese patent CN201721193063.9 achieves the resonance with the voice coil through distortion and deformation, reduce the consumed power and use the unique layered structure to reduce the thickness of the traditional damper. However, the first welding section and the second welding section are arranged the elongated portion located at the upper and lower ends of the outer circle, the cable must be passed through the damper. The installation process is more complex and the cable is easy to break as the vibration of the damper.

### SUMMARY OF THE INVENTION

In order to overcome the defects of the prior art, the present invention provides a kind of conductive plane damper, which includes pairs of voice coil welding point and wire welding point arranged in an inner circle and an out circle respectively, a connecting part arranged with a copper, thereby realizing electrical conduction of the voice coil and the supply power. The thickness of the conductive plane damper is only 0.05˜3 mm. The speaker with the conductive plane damper is electric conduction through the conductive plane damper, avoids the usage of a lead wire, thereby greatly reducing the thickness of the speaker and avoids the speaker losing sounds because of the breaking of the lead wire and prolongs the usage life of the product and optimizes the production process of the product.

The technical proposals of the present invention are as follows: a conductive plane damper includes an outer circle, an inner circle and several connecting parts; the several connecting parts are evenly distributed between the outer circle and the inner circle, connecting the outer circle and the inner circle; the conductive plane damper are provided with at least two pairs of voice coil welding points and wire welding points; the voice coil welding points are arranged on the inner circle, the wire welding points are arranged on the outer circle.

Preferably, at least the two pairs of voice coil welding points and wire welding points are electrical conduction through copper foils, at least a part of the copper foils are arranged on the connecting parts.

Preferably, at least one pair of the connecting parts are provided with the copper foils.

Preferably, the outer circle is provided with one, two or more rings, adjacent the rings are connected by the connecting part.

Preferably, each of the wire welding points is provided with a through hole used for assembling the power supply wire.

Preferably, the outermost part of the outer circle extends at least one protrusion in the radial direction of the conductive plane damper, and the wire welding point is disposed on the protrusion.

Preferably, the conductive plane damper includes a substrate layer, one end surface of the substrate layer is bonded with a first insulating layer with glue, the first insulating layer is bonded with a copper foil layer with glue, and the copper foil layer is bonded with a second insulating layer with glue; the first insulating layer coincides with the substrate layer; the copper foil layer and the second insulating layer coincides with a part or all of the substrate layer.

Preferably, the substrate layer is made from manganese sheet, stainless steel, plastic, chemical material or fiber material.

Preferably, the thickness of the conductive plane damper is 0.05˜mm-3 mm.

The beneficial effects of the present invention are as follows: The conductive plane damper in the present invention is provided with voice coil welding points on the inner circle and wire welding points on the outer circle, the voice coil welding points and the wire welding points are electric conduction by the connecting parts, thereby realizing the electric conduction between the voice coil and the power supply wire. The thickness of the conductive plane damper is 0.05˜mm-3 mm. A speaker with the conductive plane damper avoids the usage of a lead wire and the speaker losing sound because of breaking of the lead wire, thereby greatly reducing the thickness of the conductive plane damper and increasing the quality of the speakers. In addition, the cables are installed at the wire welding points of the outer circle, the cables do not need to bypass the conductive plane damper and will not vibrate with the conductive plane damper, thereby avoiding the cables break, extending the service life and the reliability of the product. The wire welding points are arranged in the outer circle to facilitate the installation of the cables and optimize the production process.

### BRIEF DESCRIPTION OF THE DRAWINGS

FIG. 1 shows a perspective view of the conductive plane damper according to the present invention.

FIG. 2 shows the other perspective view of the conductive plane damper according to the present invention.

FIG. 3 shows another perspective view of the conductive plane damper according to the present invention.

FIG. 4 shows an section view of the conductive plane damper with the copper foil according to the present invention.

### EMBODIMENTS

In order to make the objects, the technical solutions and the technical effect of the present invention are more clear, and the present invention is further explained below in combination with specific embodiments. It should be understood that the specific embodiments described herein are used only for interpreting the invention and are not used to define the invention.

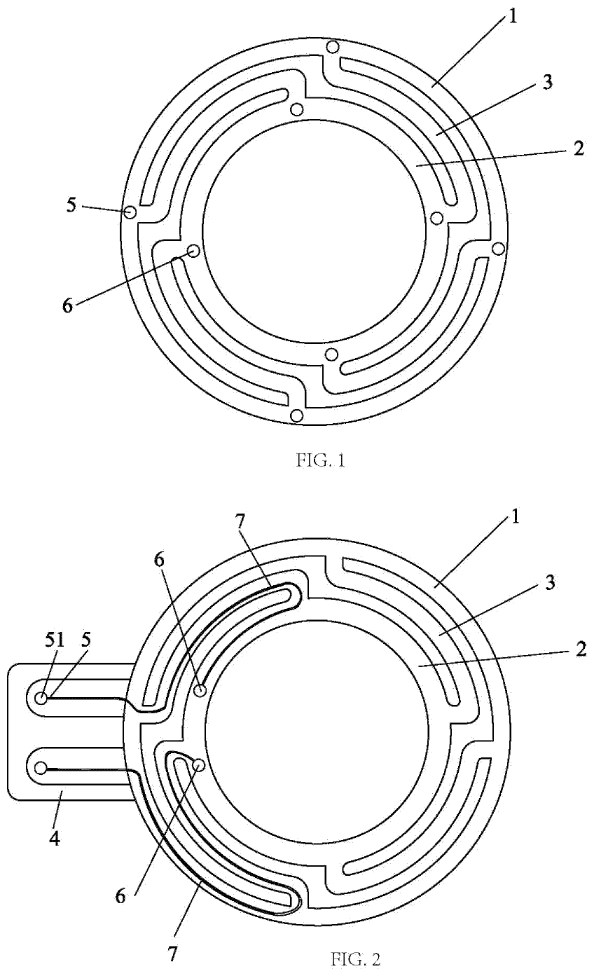

Referring to FIGS. 1, 2 and 3, a conductive plane damper includes an outer circle 1, an inner circle 2 and several connecting parts 3. The inner circle 2 lies in the outer circle 1, several connecting parts 3 are evenly distributed between the outer circle 1 and the inner circle 2, and a head end and a tail end of each of the connecting parts 3 are respectively fixedly connect with the outer circle 1 and the inner circle 2. With these hollow-out structure, the thickness and weight of the conductive plane damper are greatly reduced, and the traditional damper structure that requires concave and convex lines can be eliminated. The resonance of the conductive plane damper which is a very thin and very light and the voice coil improves the sound effect.

The outer circle 1 and the inner circle 2 are arranged pairs of wire welding points 5 and voice coil welding points 6. The wire welding points 5 and the voice coil welding points 6 are used to assemble the power supply wires. The wire welding points 5 are arranged on the outer circle 1, the voice coil welding points 6 are arranged on the inner circle 2. The wire welding points 5 and the voice coil welding points 6 are electrical conduction through copper foils 7, at least a part of the copper foils 7 are disposed on the connecting parts 3 and extends to the corresponding wire welding points 5 and the voice coil welding points 6 to realize electrical conductive. The voice coil, the wire and the conductive plane damper are electrical conductive. The conductive plane damper is used in a speaker, it can avoid using a lead wire, so that the speaker does not need to provide vibration space for the lead wire, which greatly reduces the thickness of the speaker and avoids that the speaker loses sound because of the break of the lead wire, therefor improving the quality of the speaker.

Preferably, each of the wire welding points 5 is provided with a through hole 51 used for assembling the wire, it is easy to install and highly efficient.

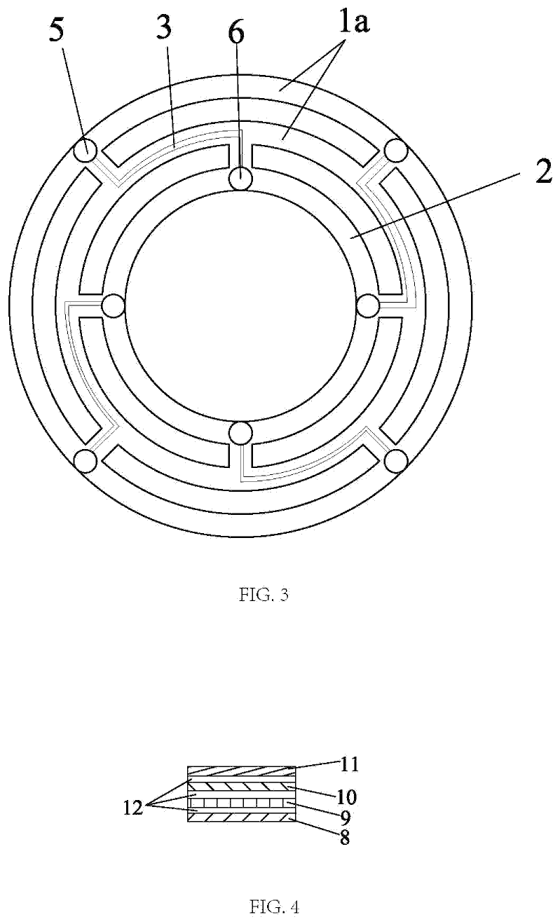

Referring to FIG. 3, preferably, when the speaker is small, the conductive plane damper requires only a circle of the ring 1a to meet the requirements; when the speaker is larger, the radiation of the conductive plane damper requires to be enlarged accordingly. Therefor, the outer circle 1 requires to be two or more rings 1a, and adjacent the rings 1a are connected by the connection parts 3.

Referring to FIG. 2, the outermost part of the outer circle 1 extends at least one protrusion 4 in the radial direction of the conductive plane damper, and the wire welding points 5 are disposed on the outer circle 1 or the protrusion 4, the power wire does not need to bypass the conductive plane damper so as to avoid the simultaneous vibration of the power wire and the conductive plane damper, prolong the service life of the wire.

Preferably, the connecting parts 3 are straight or curve like S-shaped, ∫-shaped, W-shaped, M-shaped, and the like. It should be understood that the present invention does not define the shape of the connecting parts 3 as long as the object of the present invention can be achieved.

Preferably, the connecting parts 3 are provided as least two or more. It should be understand that the present invention does not define the number of the connecting parts 3 as long as the object of the present invention can be achieved. The connecting parts 3 are evenly arranged between the outer circle 1 and the inner circle 2 so that the vibration of the conductive plane damper are uniform and stable.

Preferably, referring to FIG. 4, the conductive plane damper includes a substrate layer 8, one end surface of which is bonded with a first insulating layer 9 with glue 12, the first insulating layer 9 is bonded with a copper foil layer 10 with the glue 12, and the copper foil layer 10 is bonded with a second insulating layer 11 with the glue 12; the first insulating layer 9 coincides with the substrate layer 8; the copper foil layer 10 and the second insulating layer 11 coincides with part or all of the substrate layer 8.

Preferably, the substrate layer 8 is made from manganese sheet, stainless steel, plastic, chemical material or fiber material.

Preferably, the thickness of the conductive plane damper is 0.05 mm-3 mm.

The above content is a further detailed description of the present invention in combination with the specific preferred embodiments, and it cannot be determined that the specific embodiment of the present invention is limited to these descriptions. For those ordinary skilled in the technical art, the architectural form can be flexible and can derive a series of products without departing from the conception. Only a number of simple deductions or replacements shall be deemed to be within the scope of patent protection of the claims determined by the present invention.

1. A conductive plane damper, comprising an outer circle, an inner circle and several connecting parts evenly distributed between said outer circle and said inner circle and connecting said outer circle and said inner circle; said conductive plane damper are provided with at least two pairs of voice coil welding points and wire welding points; said voice coil welding points are arranged on said inner circle, said wire welding points are arranged on said outer circle.

2. The conductive plane damper according to claim 1, wherein each pair of said voice coil welding points and wire welding points are electrical conduction through copper foils, at least a part of said copper foils are arranged on said connecting parts.

3. The conductive plane damper according to claim 2, wherein at least one pair of said connecting parts are provided with said copper foils.

4. The conductive plane damper according to claim 1, wherein said outer circle is provided with one, two or more rings, adjacent said rings are connected by said connecting part.

5. The conductive plane damper according to claim 1, wherein each of said wire welding points is provided with a through hole used for assembling a power supply wire.

6. The conductive plane damper according to claim 1, wherein an outermost part of said outer circle extends at least one protrusion in the radial direction of said conductive plane damper, and said wire welding points are disposed on said protrusion.

7. The conductive plane damper according to claim 1, wherein comprising a substrate layer, one end surface of said substrate layer is bonded with a first insulating layer with glue, said first insulating layer is bonded with a copper foil layer with glue, and said copper foil layer is bonded with a second insulating layer with glue; said first insulating layer coincides with said substrate layer; said copper foil layer and said second insulating layer coincides with part or all of said substrate layer.

8. The conductive plane damper according to claim 7, wherein said substrate layer is made from manganese sheet, stainless steel, plastic, chemical material or fiber material.

9. The conductive plane damper according to claim 1, wherein a thickness of said conductive plane damper is 0.05 mm-3 mm.
